(19) United States
(12) Patent Application Publication
(10) Pub. No.: US 2009/0108705 A1
(43) Pub. Date: Apr. 30, 2009

(54) Bio-electromechanical device

(76) Inventors: Antonio Carcaterra, Roma (IT); Michele Mazzanti, Roma (IT)

Correspondence Address: OHLANDT, GREELEY, RUGGIERO & PERLE, LLP, ONE LANDMARK SQUARE, 10TH FLOOR, STAMFORD, CT, 06901, US

(21) Appl. No.: 11/921,712

(22) PCT Filed: Jun. 6, 2006
(86) PCT No.: PCT/IB2006/001486

§ 371 Date: Dec. 6, 2007

(30) Foreign Application Priority Data
Jun. 6, 2005 (IT) RM2005A000291

(51) Int. Cl. H02N 11/00

(52) U.S. Cl. 310/300

(57) ABSTRACT

Bio-electromechanical device capable to convert electrochemical potential energy stored in a both animal or plant cellular system to mechanical energy. This bio-electromechanical device has sizes varying in the order of microns, with maximum electric voltages near 100 mV, currents in the order of nA and associated power in the order of 10⁻¹⁰ W. The device uses the membrane potential, and specifically the action potential activation of an excitable cell, to power an electromechanical circuit which comprises at least a resistance, a capacitor and a mechanical oscillator connected to one of the capacitor plates. The resulting system is a bio-electromechanical system capable of self-oscillations triggered by a limit cycle in which the oscillating mechanical element, having different possible constructions, is the member that produces mechanical energy. The latter component can directly drive a user micro-device.

### FIELD OF THE INVENTION

The present invention refers to a bio-electromechanical device capable of converting the electrochemical potential energy stored in an animal or plant cellular system to mechanical energy.

### STATE OF THE ART

Different devices are known, capable of converting electromechanical potential energy, stored in a cellular system as a human one, to mechanical energy.

One of the problems that these devices may exhibit, is to obtain an optimal operation with effective miniaturization. There is still the need to achieve a device enabling to overcome the aforesaid drawbacks.

### SUMMARY OF THE INVENTION

The primary aim of the present invention is to achieve a bio-electromechanical device capable of using the membrane potential, and specifically the action potential activation of at least one excitable cell, in order to feed an electromechanical circuit which comprises at least one resistance, one capacitor and one mechanical oscillator connected to one of the plates of the capacitor. The present invention is intended to obtain the aforesaid aim by achieving a bio electromechanical device which, according to claim 1, comprises at least one animal or plant cell body, storing electrochemical potential energy produced by different concentrations of ion species between the inside and the outside of the cell body, at least one electromechanical microresonator coupled by coupling means to said at least one cell body, wherein said cell body and said electromechanical microresonator define a system in which the microresonator is adapted to cyclically excite the action potential of said cell body in order to produce periodic oscillations of said system so that the oscillation thereof produces a usable source of mechanical energy.

The bio-electromechanical device or bio-motor of the invention has a size ranging approximatively from 10 to 200 microns, preferably from 20 to 100 microns, with maximum electrical voltages near 100 mV, currents in the order of nA and associated power in the order of 10⁻¹⁰ W. The coupling means between electromechanical microresonator and said at least one cell body comprise at least one resistor and, possibly, one or more impedances.

The mechanical oscillator is integrally fixed to the mobile plate of the capacitor, whereas the other plate results being fixed.

The resulting system is a bio-electromechanical system capable of self-oscillations triggered by a limit cycle in which the oscillating mechanical element, having different possible constructions, is the member that produces mechanical energy.

The latter component can directly drive a user microdevice.

### BRIEF DESCRIPTION OF THE FIGURES

Further features and advantages of the invention will be more apparent in view of the detailed description of preferred embodiments, though not exclusive, of a bio electromechanical device, illustrated by way of example and not by way of limitation with the aid of the accompanying drawing figures, wherein

FIG. 1 represents an electromechanical diagram of the device of the invention;

FIG. 2 represents an electrical diagram equivalent to an excitable membrane;

FIG. 3 comprises two graphs representing the trend of the functions controlling the dynamics of the ion channels;

FIGS. 4, 5, 6 represent the trends of current and voltage at the ends of a resistance R as its value varies;

FIG. 7 represents the trend of the maximum variations of the membrane potential as a function of resistance R;

FIG. 8 represents the value of period T, corresponding to the fundamental harmonic of the process, as resistance R varies;

FIG. 9 represents a first embodiment of an electromechanical part of the device of the invention;

FIG. 10 represents the trend of the voltages in R in the case of the embodiment in FIG. 9;

FIG. 11 represents the trend of the displacements of the oscillator in proximity to one plate of the capacitor in the case of the embodiment of FIG. 9;

FIG. 12 schematically represents a second embodiment of an electromechanical part of the device of the invention.

### DETAILED DESCRIPTION OF PREFERRED EMBODIMENTS OF THE INVENTION

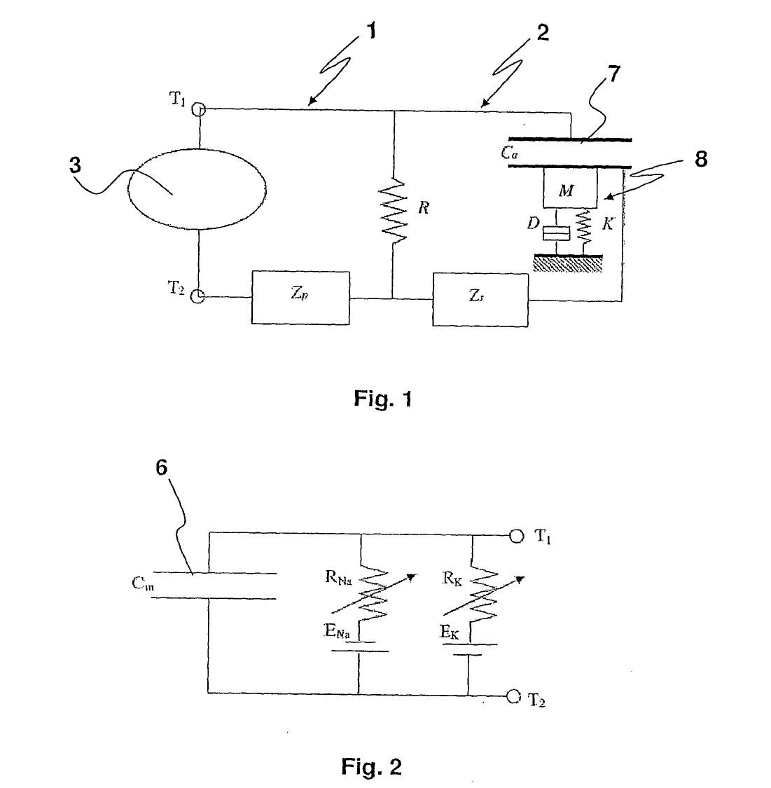

In its general configuration, as illustrated in FIG. 1, the device consists of two coupled circuits: the driving circuit 1, on the left, and the electromechanical converting circuit 2, on the right.

The first circuit 1 comprises at least one excitable cell 3, the membrane of which is electrically connected by the terminals T₁, T₂, connected to the internal and external parts thereof, to a resistive element or resistor R as well as to an impedance Zₚ.

The converting circuit 2 is generally conceived as a purely passive electromechanical circuit. The electric part is characterised essentially by the presence of a capacitor 7 of capacitance Cₐ as well as by an impedance Zₛ (see FIG. 1). The mechanical part is comprised of an elastic mechanical oscillator 8, which can be constructively produced in different ways. Some construction possibilities is indicated below. In the basic diagram of FIG. 1, such oscillator 8 is simply schematised by a mass M, an element of stiffness K and a dissipator of constant D.

Although an appropriate selection of the impedances Zₚ and Zₛ may contribute to optimise the performance of the device, the operation necessarily requires the sole presence of the resistor R in parallel to the capacitor 7, assuming Zₚ=0 and Zₛ=0 for a preliminary analysis.

If the system is appropriately designed, the resistor R should not have a too large value, in which case the membrane current is so small that it does not trigger the action potential, nor a too small value, in which case the current is too high and the cell reaches quickly refractoriness conditions. For R in an assigned range of values (see below), the generation mechanism of the action potential produces a periodic sequence of current spikes in the driving circuit 1. A potential difference, periodic as well, is generated at the ends of R, inducing a periodic charge storage on the capacitor 7. The electrostatic action between the plates of the capacitor 7 produces a periodic force on the mobile plate, integral with the mechanical oscillator 8, exciting the oscillations thereof. The system thus conceived produces the desired biomotor effect consisting of the conversion of the electrochemical energy of the excitable membrane to mechanical energy of the elastic mechanical oscillator, activating a limit cycle of the bio-electrical-mechanical system.

A mathematical model of the system just described allows to deduce how the bio-electrical-mechanical device or bio-motor is effectively capable of self-oscillations. Furthermore, some numerical simulations allow to deduce a possible construction configuration that guarantees its functionality.

The electrical behaviour of the cell can be quantitatively described in this context by the Hodgkin & Huxley model.

The electrical diagram equivalent to the excitable membrane is depicted in FIG. 2. The membrane is schematised as a capacitor 6 of capacitance Cₘ, the dielectric of which is formed by the lipid layer. Such a layer is run through by selective ionic channels, i.e., only permeable to some ionic species. The present model is limited to considering sodium ions and potassium ions. The ionic channels are represented in the diagram by variable resistors R_{Na} and R_{K}. The value of their resistance, or of their conductance, depends on the potential difference at the ends of the cellular membrane, i.e., the ionic channels are voltage-dependent. This feature is important for the operation of the bio-electrical-mechanical device described below. In series to the variable resistors R_{Na} and R_{K}, there are the so-called ionic batteries, namely generators of constant potential difference E_{Na} and E_{K} adapted to represent the electromotive forces due to the differences in ionic concentration between the outside and the inside of the cell. Specifically, potassium ions K⁺ have a higher concentration on the inside of the cell body, while sodium ions Na⁺ have a higher concentration on the outside surface of the cell. In resting conditions, the membrane is almost impermeable to sodium ions whereas it is weakly permeable to potassium ions which, under the effect of the difference in concentration, exit the cell until the electrostatic forces balance the diffusive actions. The potential difference established on the cell membrane at equilibrium, controlled by potassium ions, is Eₖ=−75 mV.

The electrical dynamics of the membrane thus schematised is described by the four non-linear differential equations system:

$$\{ \begin{matrix}{C}_{m} \dot{V} = {\overline{g}}_{Na} {m}^{3} h ( {E}_{Na} - V ) + {\overline{g}}_{K} {n}^{4} ( {E}_{K} - V ) + {I}_{{T}_{1} {T}_{2}} \\ \dot{n} = \frac{{n}_{∞} ( V ) - n}{{τ}_{n} ( V )} ; \dot{m} = \frac{{m}_{∞} ( V ) - m}{{τ}_{m} ( V )} ; \dot{h} = \frac{{h}_{∞} ( V ) - h}{{τ}_{h} ( V )}\end{matrix} \qquad ( 1 )$$

where:
Cₘ, capacitance of the cell membrane
V, potential difference at the ends of the cell membrane
g_{Na}, g_{K}, conductance constants of the ionic channels
E_{Na}, E_{K}, ionic electromotive forces (emf)
m, h, activity indexes of sodium ionic channels
n, activity index of potassium ionic channel
m∞(V), h∞(V), n∞(V), functions of the potential (known from Hodgkin & Huxley's theory)
τₙ(V), τₘ(V), τₕ(V), functions of the potential (known from Hodgkin & Huxley's theory)
I_{T1T2}, current between terminals T₁ and T₂.

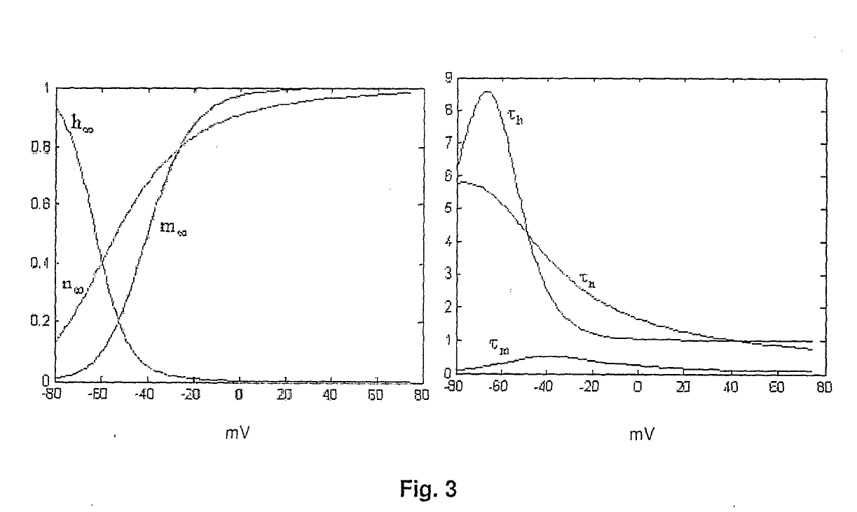

The first of the equations (1) is the balance equation of the currents (see diagram in FIG. 2), the remaining three describe the ionic channels dynamics, namely the constitutive relations for the variable resistances of the diagram in FIG. 2. More precisely, the terms g_{Na}m³h(E_{Na}−V), g_{K}n⁴(E_{K}−V) represent the sodium and potassium ionic currents flowing through the cell membrane. The ionic channels conductances are g_{Na}m³h, g_{K}n⁴ and depend on the potential produced at the ends of the membrane. The functions, on which m, n and h depend, that control the channels dynamics are known and their trends are provided in the graphics of FIG. 3.

The equations system (1) describes the active properties of the membrane. The electrostatic equilibrium condition is for

V=E_{K}, m∞(E_{K})=0, h∞(E_{K})≈0,9, n∞(E_{K})=0,15

all ionic currents being blocked and the external current I_{T1T2} being zero. In such conditions only potassium channels, the only ones being active, control the equilibrium. Even a transitory disturbance, provided that it has a sufficient intensity, on the membrane potential from the equilibrium value V=E_{K}=−75 mV triggers the activation process of the action potential: the sodium channels conductances are activated (effect of index m), breaking equilibrium. A sodium ions flow is established towards the inside of the cell body, or simply cell, under the effect of the difference in concentration, bringing the potential towards zero. Such a variation in membrane potential leads to a complete opening of the sodium channels to a maximum. Closure of the same channels follows, activated by index h. A greater activation of the potassium channel (index n) occurs at the same time, which produces an ions flow in the opposite direction, exiting the cell body again under the effect of the difference in concentration. Such a flow brings again the potential towards the equilibrium value for the potassium, V=E_{K}=−75 mV, also partially shutting the potassium channel again with the index n decreasing when the potential returns to equilibrium. Therefore, a strong enough transitory disturbance of the membrane potential is followed by the development of a two-way ionic flow entering (sodium ions) and then exiting (potassium ions) the cell body.

By exploiting such a mechanism in a cyclic way, it is possible to induce periodic activation sequences of the action potential in the driving circuit, i.e., a limit cycle of the bio-electric system.

To this purpose we consider the diagram in FIG. 2. We connect a resistance R to the terminals T₁ and T₂. This produces a discharge process in the membrane, that is in the capacitor 6, which may be fast or slow depending on the value of R, varying the potential difference thereof. The current in R is opposed by the flow of K⁺ ions, which are expelled from the cell body, the potassium channels always being weakly active even at equilibrium (n∞≈0.15 even at the equilibrium potential V=Eₖ=−75 mV, as in FIG. 3), because of the modified electrostatic equilibrium. If the current in R is weak, the weak activation of the potassium channel is sufficient to produce a compensating current such as to maintain the membrane potential substantially constant. In such a case, the action potential cannot be activated. With a small enough resistance R, the current intensity in R is instead high to the point that the flow of K⁺ ions with the weakly activated channels is unable to compensate it. In such a case, the membrane potential varies. The variation in potential difference caused by the current flow in R produces the variation in the conductance of the sodium channels that open (see the trend of indexes m_{∞}, h_{∞} passing from Eₖ=−75 mV to positive potentials). Thus, a flow of Na⁺ ions entering the cell body occurs, enhancing the depolarisation process due to the initial current in R. The depolarisation leads to the subsequent closing of the sodium channels because of the decay of h_{∞} as the potential increases; furthermore, this induces a greater opening of the potassium channels (increase of n_{∞} when the potential increases), which generates a charge flow in the opposite direction. A mechanism antagonist to that one due to the current in R is thus activated, returning the potential to a value near equilibrium. In such a condition, the current in R activates the process again and another spike is generated and so forth (limit cycle).

Finally, the current in R should not be too intense, otherwise, while the opening of the sodium channels and their subsequent closing is surely activated, the activation of the antagonist current of potassium ions exiting the cell body could be too weak to compensate that one in R. In such conditions, the potassium flow cannot return the potential to the equilibrium value and electric oscillations are not triggered in the circuit. The triggering of the oscillations is thus dependent on an appropriate choice of the value of R.

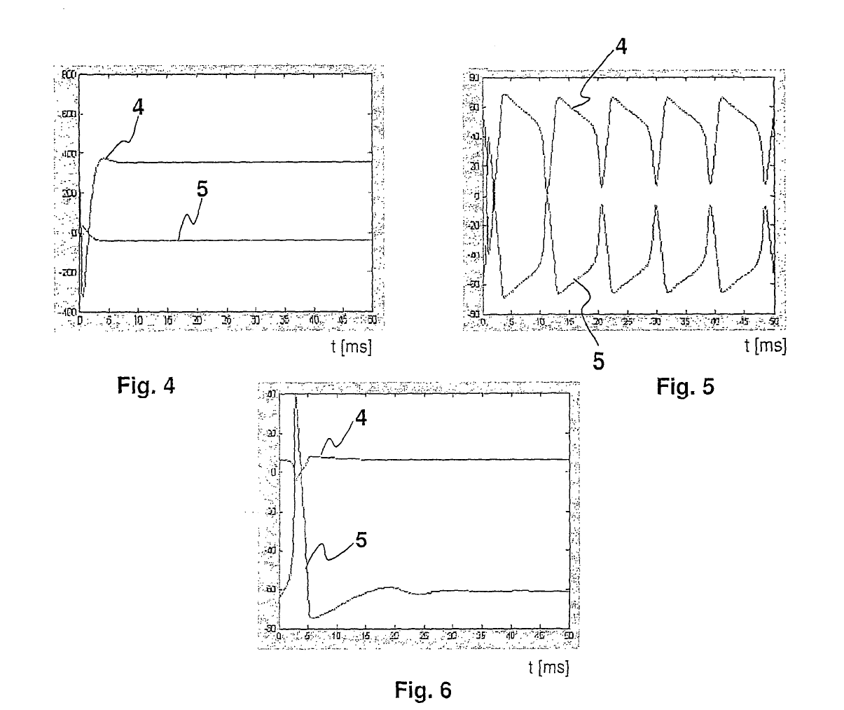

The results of three simulations, obtained combining the equations system (1) with I_{T1T2}=V/R—using the characteristic functions shown in FIG. 3 and with typical electrical data for a cell membrane Cₘ=1 μF/cm², g_{Na}=120 mS/cm², g_{K}=36 mS/cm² (using the convention of referring capacitance, conductances and currents to the cell surface unit)—are shown in FIGS. 4, 5 and 6 respectively with three different values of G=1/R:

G=10 mS/cm², G=1 mS/cm², G=0,1 mS/cm²

respectively equivalent to coupling resistances:

R=1.27·10⁶Ω, R=1.27·10⁷ Ω, R=1.27·10⁸ Ω

having assumed a cell diameter of approximatively 50 μm. Time is expressed on the x-axis in msec, the currents are expressed on the y-axis in μA/cm² and the voltages in mV.

The trends of the current in the resistance R are indicated with the numeral reference 4; the trends of the voltages at the ends of the resistance R are, instead, indicated with the numeral reference 5.

It should be noted that the sequence of neuronal spikes is activated only for the intermediate value of resistance (FIG. 5), namely a limit cycle of the biological system is activated only in such conditions.

A more accurate study reveals that the range of values of R activating the limit cycle is more precisely:

0.76·10⁷ Ω<R<8.225·10⁷ Ω (2)

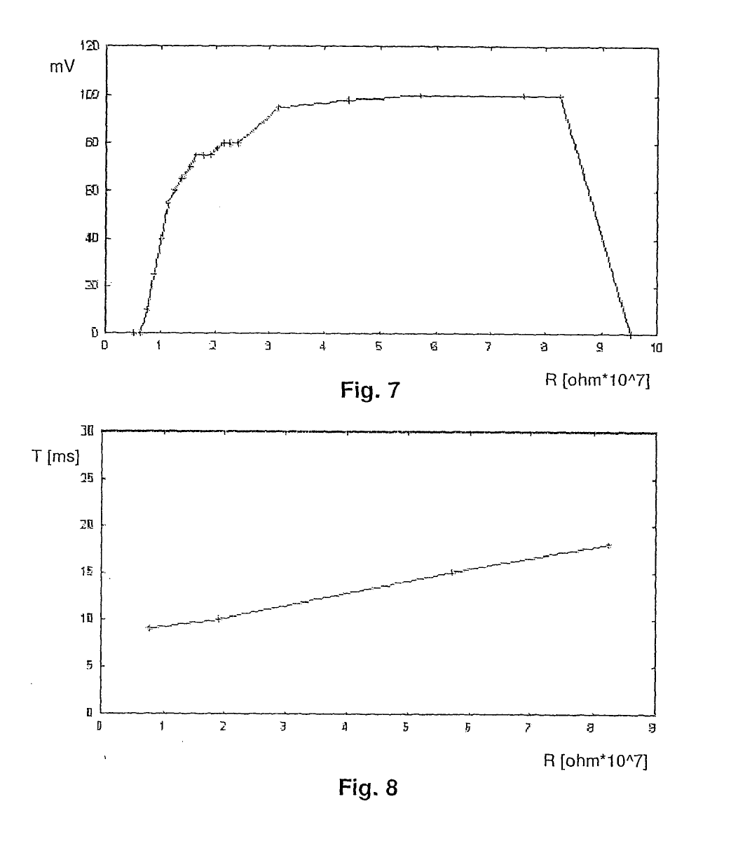

This is the first project result for the bio-electrical-mechanical device of the invention. The maximum observed variations of the membrane potential (in mV) are reported in FIG. 7, depending on resistance R (the values on the x-axis in Ω are to be multiplied by 10⁷); FIG. 8 shows the value of the period T (in msec), corresponding to the fundamental harmonic of the process, again upon variation of coupling resistance R.

Turning to the analysis of the driving circuit 1, namely a biological-electrical circuit, coupled to the electromechanical converting circuit 2 according to the diagram in FIG. 1, the equations of the bio-electromechanical system become:

$$\{ \begin{matrix}{C}_{m} \dot{V} = {\overline{g}}_{Na} {m}^{3} h ( {E}_{Na} - V ) + {\overline{g}}_{K} {n}^{4} ( {E}_{K} - V ) + {I}_{R} + {I}_{C} \\ {I}_{R} = \frac{V}{R} , {I}_{C} = - {C}_{a} \dot{V} , {C}_{a} = \frac{{ɛ}_{0} S}{( {d}_{0} - x )} \\ \dot{n} = \frac{{n}_{∞} ( V ) - n}{{τ}_{n} ( V )} , \dot{m} = \frac{{m}_{∞} ( V ) - m}{{τ}_{m} ( V )} , \dot{h} = \frac{{h}_{∞} ( V ) - h}{{τ}_{h} ( V )} \\ M \ddot{x} + D \dot{x} + Kx = \frac{{C}_{a}^{2} {V}^{2}}{2 S {ɛ}_{0}}\end{matrix}$$

where I_{R}, I_{C}, Cₐ, ε₀, S, d₀, x are, respectively, the current in resistance R, the current in the capacitor 7 coupled to the elastic mechanical oscillator 8, the capacitance of said capacitor 7, the constant of the relative dielectric, the plate surface, the distance between the plates, the displacement of the elastic mechanical oscillator 8.

It should be noted that the electrostatic actuation of the mechanical oscillator 8 through the capacitor 7 (which non-linearly depends on x) produces an amplification effect of the motion x(t). Indeed, if a first-order Taylor series expansion of Cₐ(x) is carried out and only the first harmonic of V²(t) is considered, a Mathieu equation is obtained, in which harmonic fluctuations of the stiffness, tuned on the frequency of the external forcing excitation with subsequent amplification of the oscillatory motion of the mass M, are produced.

For R=1.9·10⁷ Ω, FIG. 8 shows that the fundamental period of the triggered periodic process is approximatively T=10 msec. To obtain a sufficient amplification of the motion of the mechanical oscillator 8, it is preferable to tune its frequency with that one of the driving circuit.

Thus, it would be appropriate that

$$\sqrt{\frac{K}{M}} = \frac{2 π}{10 ms}$$

On the basis of the aforementioned mathematical model it is possible to carry out a simulation with the following parameters:

R=1.9·10⁷Ω, K=9.9·10⁻⁶ N/m, M=2.57·10⁻¹¹ kg

D=3.1·10⁻¹⁰ Ns/m (δ=0.025),d₀=4.5 μm, ε₀=8.85·10⁻¹² F/m. S=1.6·10⁻⁹ m²

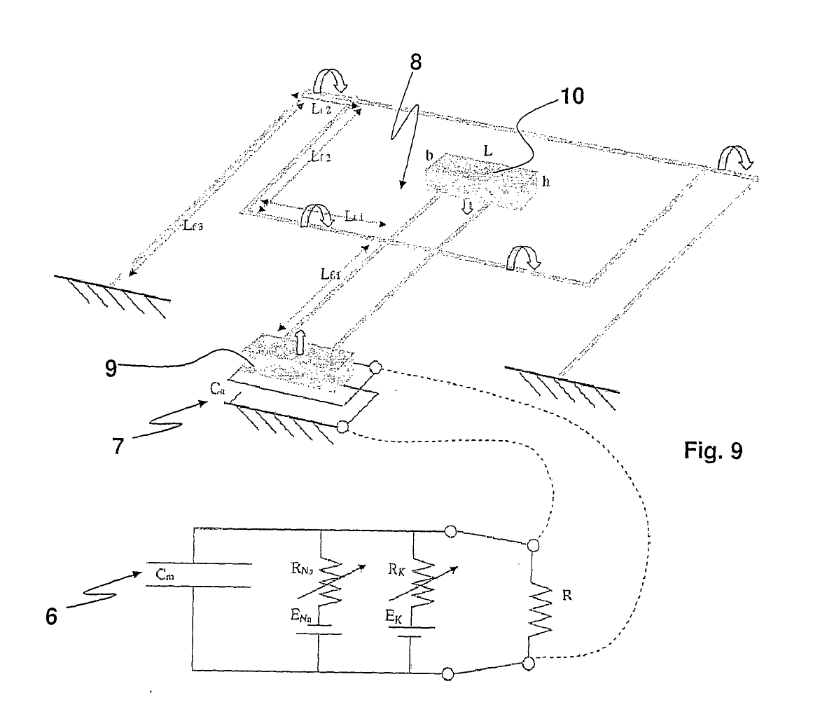

In particular, the values of K and M, which serve to achieve the desired tuning, can be obtained by means of a structure as that illustrated in FIG. 9. This is a structure constructed in silicon (E=1·10⁹ N/m, ρ=2.3·10³ kg/m³) in which torsion working structural elements Lₜ₁ and Lₜ₂ and flexure working structural elements L_{f1}, L_{f2} and L_{f3} have been connected in series to obtain the desired flexibility. The main dimensions of the structure, for example, can be:

$$\begin{matrix}{L}_{f 1} = 52 µ m , & section 2 µ m \times 0.3 µ m \\ {L}_{f 2} = 55 µ m & ′′ \\ {L}_{f 3} = 75 µ m & ′′ \\ {L}_{t 1} = 50 µ m , & circular section r = 0.3 µ m \\ {L}_{t 2} = 10 µ m & ′′ \\ b = 20 µ m , & h = 7 µ m , L = 40 µ m\end{matrix}$$

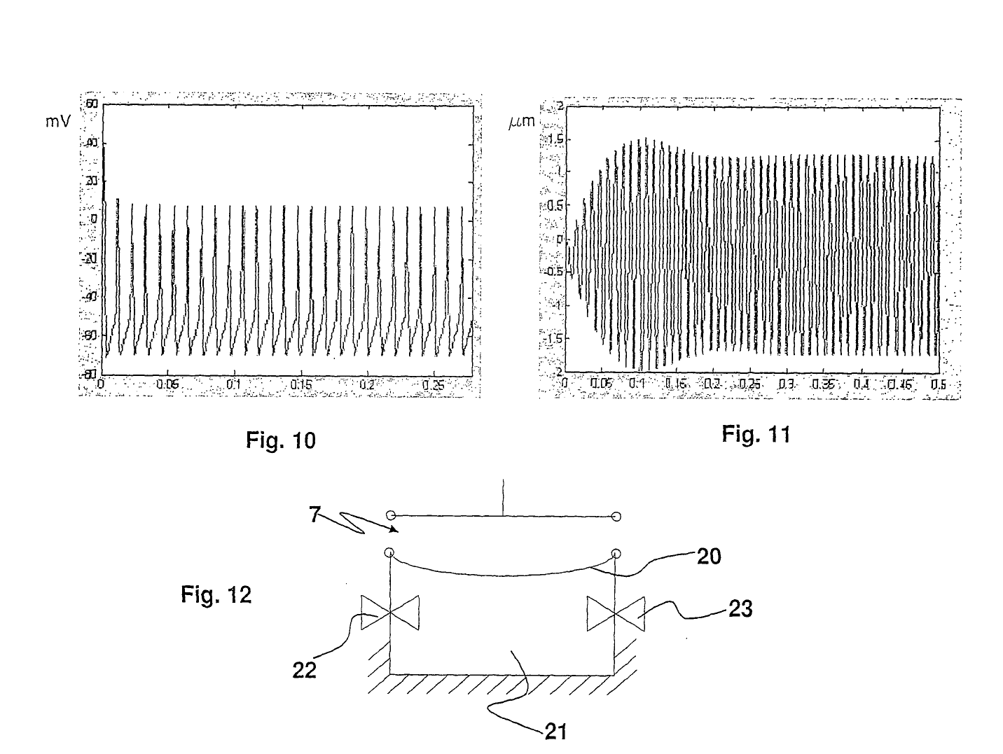

As illustrated in FIG. 11, voltages in R variable from −70 mV to some mVs (see FIG. 10) and displacements of the mechanical oscillator 8 near the mobile plate of the capacitor 7 in the order of 3 μm are obtained for a system thus sized. In this embodiment, the elastic oscillator 8 comprises two blocks 9, 10, sized b×h×L, reciprocally connected by flexure working structural elements with the block 9 fixed directly to the mobile plate of capacitor 7.

It should be noted that such a displacement is obtained with a simple electrostatic actuator, i.e., a capacitor with a single pair of facing plates. Where required by the application, the number of the pairs of plates, as generally occurs in electrostatic actuator microtechnology, may be increased with the effect of proportionally increasing the actuation force and the displacements generated. Similar considerations are valid for the number of cell bodies used in the bio-motor.

It is therefore also possible to advantageously exploit the action potential activation of a plurality of excitable cells or cell bodies, as e.g. several electrically connected neuronal cells, in order to increase the power delivered to the mechanical oscillator in proportional way with respect to the number of cells employed.

The mechanical oscillator may advantageously be used as an actuator member of any mechanical device, nowadays used in the micromotor technology, actually constituting the motor.

A preferred embodiment of the invention provides the use of the bio-electromechanical device of the invention as a micropump. The mobile plate 20 of capacitor 7 becomes, in this case, the mobile wall of a variable volume chamber 21. Chamber 21 results being provided with two one-way valves 22, 23 so that the oscillations of the mobile plate 20, which acts as an elastic membrane, produce a pulsing flow that runs through chamber 21 producing the effect of pumping a fluid, e.g. of organic origin. A diagram of this appliance is shown in FIG. 12. The two valves 22, 23 are respectively only input and output valves of the chamber. A micropump device, as the above described one, may be used to construct a micropropeller for a microvehicle capable of propulsion in an organic fluid, e.g. blood, usable e.g. for drug delivery operations. The micropump device becomes in this case a pulsing microjet reaction motor. It is possible to construct micropropellers adapted to displace a microvector both in a fluid environment and by any locomotion system on solid surface. Other embodiments of the device of the invention may comprise a plurality of capacitors 7, arranged in series and/or in parallel, as well as a plurality of cell bodies arranged in series and/or in parallel, and corresponding elastic mechanical oscillators 8.

1. A bio-electromechanical device comprising:
at least one animal or plant cell body, storing electrochemical potential energy produced by different concentrations of ion species between the inside and the outside of the cell body,
at least one electromechanical microresonator coupled by coupling means to said at least one cell body,
wherein said cell body and said electromechanical microresonator define a system in which the microresonator is adapted to cyclically excite the action potential of said cell body in order to produce periodic oscillations of said system so that the oscillation thereof produces a usable source of mechanical energy.

2. A device according to claim 1, wherein said coupling means comprise at least one resistor and possibly one or more impedances.

3. A device according to claim 2, wherein said at least one resistor has a value comprised in the range from about 0,76*10⁷ to 8,225*10⁷ Ω.

4. A device according to claim 1, wherein the electromechanical microresonator comprises at least one elastic mechanical oscillator driven by electrostatic actuation means.

5. A device according to claim 4, wherein said electrostatic actuation means comprise at least one capacitor with a first fixed plate and a second mobile plate.

6. A device according to claim 5, wherein the elastic mechanical oscillator is integrally fixed to said second mobile plate.

7. A device according to claim 6, wherein the elastic mechanical oscillator comprises two blocks, reciprocally connected by flexure working structural elements, with one of the blocks fixed directly to the mobile plate of the capacitors.

8. A device according to claim 6, wherein the elastic mechanical oscillator comprises a variable volume chamber, the wall of which is the second plate of capacitors, said chamber being provided with two one-way input and output valves so that the oscillations of the second plate may produce a pulsing flow of a fluid running through the chamber itself.

9. A device according to claim 1, wherein there are provided a plurality of excitable cell bodies arranged in series and/or in parallel, a plurality of capacitors arranged in series and/or in parallel and corresponding elastic mechanical oscillators.

10. A device according to claim 1, wherein said device may be used to construct a micropropeller for a microvehicle capable of propulsion in an organic fluid or by any locomotion system on solid surface.

11. A device according to claim 1, wherein the mechanical oscillator is used as actuator member of any mechanical device actually constituting the motor thereof.
